(19) United States
(12) Patent Application Publication
(10) Pub. No.: US 2026/0042223 A1
(43) Pub. Date: Feb. 12, 2026

(54) SYSTEM AND METHOD FOR CONTROLLING ROBOT USING ON-DEVICE AI

(71) Applicant: 1THEFULL PLATFORM LIMITED, Seoul (KR)

(72) Inventors: SEUNG-YUB KOO, Gyeonggi-do (KR); JOON GU HEO, Seoul (KR)

(21) Appl. No.: 19/087,807

(22) Filed: Mar. 24, 2025

(30) Foreign Application Priority Data
Aug. 9, 2024 (KR) 10-2024-0106645

(51) Int. Cl. B25J 11/00; B25J 9/00; B25J 9/16; G06F 16/3329

(52) U.S. Cl. CPC B25J 11/0015; B25J 9/0003; B25J 9/161; G06F 16/33295

(57) ABSTRACT

A robot control system using on-device AI includes an on-device AI control server to distribute a smaller Large Language Model (sLLM) for on-device AI execution; an on-device AI terminal to load and execute the sLLM distributed from the on-device AI control server; and a companion robot to carry out question asking and answering interaction with the sLLM running on the on-device AI terminal and make automated conversation with a user based on the question and answer. According to the robot control system and method using on-device AI, it may be possible to enable direct questioning/answering between the terminal and the robot by using the sLLM installed on each user's terminal without using LLM equipped on a platform, thereby solving the problem with network load caused by questions/answers, enhancing the optimized learning capabilities for each user, and increasing intimacy in conversation with the user.

### CROSS-REFERENCE TO RELATED APPLICATION AND CLAIM OF PRIORITY

This application claims the benefit under 35 USC § 119 of Korean Patent Application No. 10-2024-0106645 filed on Aug. 9, 2024, in the Korean Intellectual Property Office, the entire disclosure of which is incorporated herein by reference for all purposes.

### BACKGROUND

### 1. Technical Field

The present disclosure relates to a robot control system and method, and more particularly, to a robot control system and method using on-device artificial intelligence (AI).

### 2. Description of the Related Art

The present invention was supported by the national research and development program (Project identification number: 1415190005; Project number: P0025661; Department name: Ministry of Trade, Industry and Energy; Project management (professional) organization name: Korea Institute for Advancement of Technology; Research program title: Industrial Technology International Cooperation; Research project title: Human care solutions based on AI data analysis and monitoring systems; Contribution ratio: 1/1; Project execution organization name: 1THEFULL PLATFORM LIMITED.; Research period: 2023.07.01-2026.06.30) awarded by Ministry of Trade, Industry and Energy. The Government has certain rights in the invention.

Recently, generative artificial intelligence (AI) such as ChatGPT has been increasingly used.

With the use of AI in robot applications, there have been many attempts to apply generative AI.

When generative AI is used in robot applications, a large language model (LLM) running on a platform server allows a plurality of robots to ask/answer questions remotely.

In this case, there may be problems with slow processing speed of the LLM and network overload or communication speed.

In particular, the use of ChatGPT exponentially increases the ChatGPT cost and reduces personal information security.

Additionally, there is a need for a continuously increasing number of servers for LLM platforms.

Recently, growing attention has been paid to companion robots, and it is important to use the optimized learning capabilities and data for users due to the characteristics of companion robots. However, the existing remote LLM platforms are not suitable for user optimization.

### SUMMARY

The present disclosure is directed to providing a robot control system using on-device artificial intelligence (AI).

The present disclosure is further directed to providing a robot control method using on-device AI.

A robot control system using on-device AI according to the above-described objective of the present disclosure may include an on-device AI control server configured to distribute a smaller Large Language Model (sLLM) for on-device AI execution; and a companion robot configured to ask and answer a question with a user by using the sLLM distributed from the on-device AI control server.

Here, the companion robot may be configured to make automated conversation with the user based on the question and answer.

Additionally, the on-device AI control server may be configured to distribute the sLLM by over-the-air programming (OTA).

A robot control method using on-device AI according to the other above-described objective of the present disclosure may include the steps of distributing, by an on-device AI control server, sLLM for on-device AI execution; and asking and answering, by a companion robot, a question with a user by using the sLLM distributed from the on-device AI control server.

Here, the robot control method using on-device AI may further include making, by the companion robot, automated conversation with the user based on the question and answer.

Additionally, the step of distributing, by the on-device AI control server, the sLLM for on-device AI execution may include distributing the sLLM by over-the-air programming (OTA).

According to the robot control system and method using on-device AI as described above, it may be possible to enable direct questioning/answering between the terminal and the robot by using the sLLM installed on each user's terminal without using LLM equipped on a platform, thereby solving the problem with network load caused by questions/answers, enhancing the optimized learning capabilities for each user, and increasing intimacy in conversation with the user.

### BRIEF DESCRIPTION OF THE DRAWINGS

FIG. 1 is a diagram of a robot control process using on-device artificial intelligence (AI) according to an embodiment of the present disclosure.

FIG. 2 to FIG. 4 are a block diagram of a robot control system using on-device AI according to an embodiment of the present disclosure.

FIG. 5 is a flowchart of a robot control method using on-device AI according to an embodiment of the present disclosure.

### DETAILED DESCRIPTION

The present disclosure may be modified in different forms and have many embodiments, and particular embodiments are shown in the drawings and specified in the detailed description for practicing the present disclosure. However, it should be understood that the present disclosure is not limited to the particular embodiments and includes all modifications, equivalents or substitutes included in the aspect and technical scope of the present disclosure. In describing each drawing, similar reference numerals are used for similar elements.

As used herein, the terms first, second, A, B, etc. may be used to describe different elements, but the elements should not be limited by the terms. These terms are used to distinguish one element from another. For example, a first element may be referred to as a second element, and likewise, a second element may be referred to as a first element, without departing from the scope of protection of the present disclosure. The term and/or includes a combination of a plurality of related items or any of the plurality of related items.

When an element is referred to as being “connected to” or “coupled to” another element, it should be understood that it can be directly connected or coupled to the other element, but intervening elements may be present. In contrast, when an element is referred to as being “directly connected to” or “directly coupled to” another element, it should be understood that there is no intervening element.

The terms as used herein are used to describe particular embodiments, but not intended to limit the present disclosure. The singular forms include the plural forms unless the context clearly indicates otherwise. It should be further understood that the term “comprise” or “have” when used in the specification, specifies the presence of the stated features, figures, steps, operations, elements, components, or a combination thereof, but do not preclude the presence or addition of one or more other features, figures, steps, operations, elements, components or a combination thereof.

Unless otherwise defined herein, all the terms used herein including technical and scientific terms have the same meaning as commonly understood by persons having ordinary skill in the technical field pertaining to the present disclosure. The terms as used herein, such as those defined in commonly used dictionaries, should be interpreted as having a meaning that is consistent with their meaning in the context of the relevant art, and will not be interpreted in an idealized or overly formal sense unless otherwise expressly defined herein.

Hereinafter, exemplary embodiments according to the present disclosure will be described in detail with reference to the accompanying drawings.

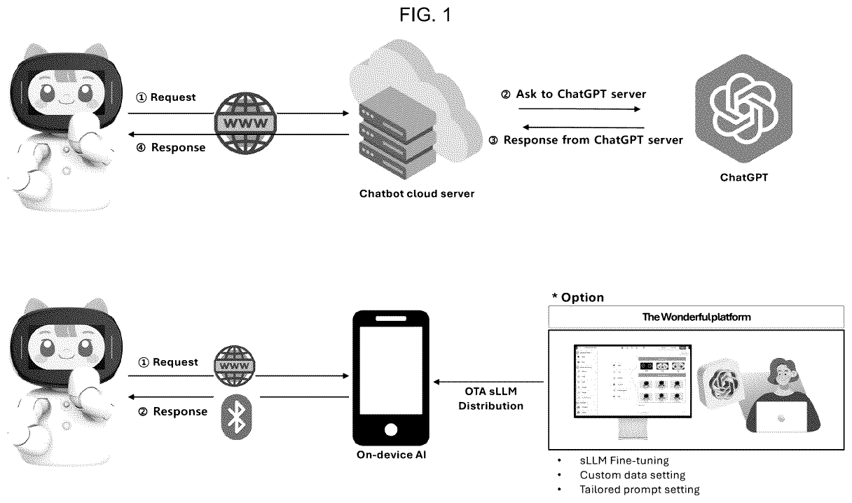

FIG. 1 is a diagram of a robot control process using on-device artificial intelligence (AI) according to an embodiment of the present disclosure.

Referring to FIG. 1, conventionally, a platform server asks/answers questions with a robot by making a connection to ChatGPT, but in the present disclosure, instead of the platform server, a smaller Large Language Model (sLLM) is installed on each user's terminal to enable direct question asking/answering with the robot on the terminal. Accordingly, optimized learning capabilities for the users are expected, and intimacy in conversation may be increased. In particular, because the previous answers may be used for the same questions as the previous questions, question asking/answering speed and conversation speed may be significantly increased.

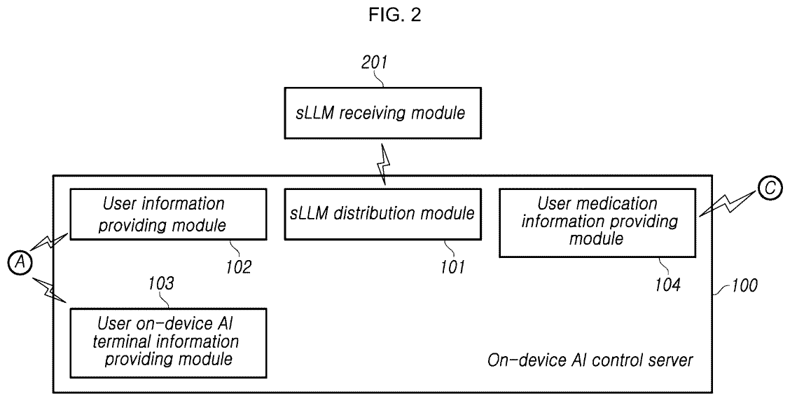

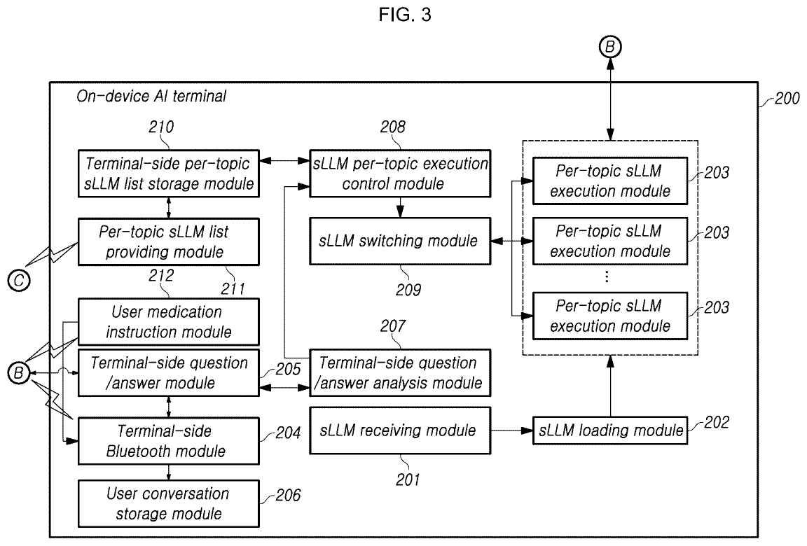

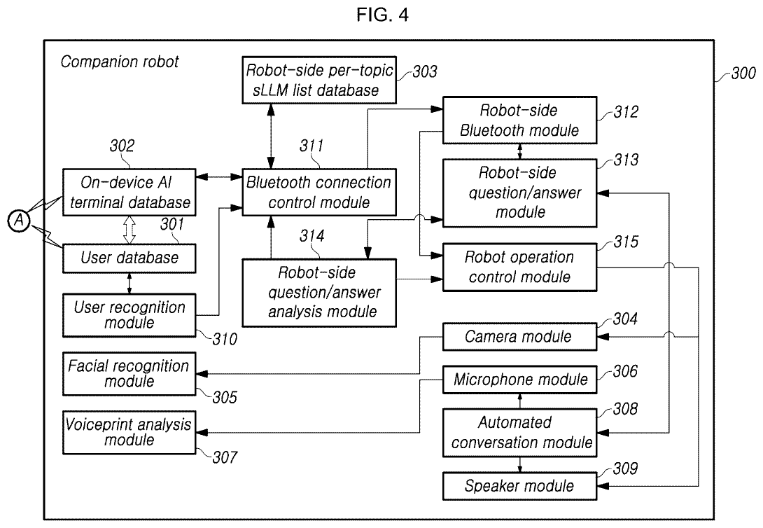

FIG. 2 to FIG. 4 are a block diagram of a robot control system using on-device AI according to an embodiment of the present disclosure.

Referring to FIG. 2 to FIG. 4, the robot control system using on-device AI according to an embodiment of the present disclosure may include an on-device AI control server 100, an on-device AI terminal 200 and a companion robot 300.

Hereinafter, a detailed description will be provided.

The on-device AI control server 100 may be configured to distribute sLLM for on-device AI execution by over-the-air programming (OTA).

The on-device AI terminal 200 may be configured to carry out question asking and answering interactions with the sLLM running on the on-device AI terminal 200 and make automated conversation with a user based on the questions and answers.

The on-device AI control server 100 may include an sLLM distribution module 101, a user information providing module 102, a user on-device AI terminal information providing module 103 and a user medication information providing module 104.

Hereinafter, a detailed description will be provided.

The sLLM distribution module 101 may be configured to distribute the sLLM to the on-device AI terminal 200.

The user information providing module 102 may be configured to provide user information of the user to the companion robot 300. Here, the user may include at least one user.

The user on-device AI terminal information providing module 103 may be configured to provide the user's on-device AI terminal information to the companion robot 300. Here, the on-device AI terminal 200 of any one user may include at least one on-device AI terminal 200.

The user medication information providing module 104 may be configured to provide the user's medication information. The companion robot 300 may be disposed at homes, nursing facilities or hospitals, and the medication information may include information about each user's medication to be continuously taken, such as medicines, timing and amount of the medicines, etc.

The on-device AI terminal 200 may include an sLLM receiving module 201, an sLLM loading module 202, a per-topic sLLM execution module 203, a terminal-side Bluetooth module 204, a terminal-side question/answer module 205, a user conversation storage module 206, a terminal-side question/answer analysis module 207, an sLLM per-topic execution control module 208, an sLLM switching module 209, a terminal-side per-topic sLLM list storage module 210, a per-topic sLLM list providing module 211 and a user medication instruction module 212.

Hereinafter, a detailed description will be provided.

The sLLM receiving module 201 may be configured to receive the sLLM distributed from the on-device AI control server 100.

The sLLM loading module 202 may be configured to load the sLLM received by the sLLM receiving module 201.

Each of a plurality of per-topic sLLM execution modules 203 may be configured to execute the sLLM loaded on the sLLM loading module 202 for each topic. Here, the topics may come in different types, for example, pictures, fishing, music, foreign languages or coding, and may be determined according to the user's conversation topics or interests.

The terminal-side Bluetooth module 204 may be configured to perform Bluetooth communication with the companion robot 300.

The terminal-side question/answer module 205 may be configured to ask and answer questions with the companion robot 300 by using the sLLM executed by each per-topic sLLM execution module 203 through the Bluetooth communication performed by the terminal-side Bluetooth module 204.

The user conversation storage module 206 may be configured to cumulatively store conversation between the companion robot 300 and the user through the Bluetooth communication performed by the terminal-side Bluetooth module 204. The cumulatively stored user conversation may be referenced in real-time conversation of the companion robot 300.

The terminal-side question/answer analysis module 207 may be configured to perform real-time analysis of the question and answer with the companion robot 300 performed by the terminal-side question/answer module 205.

The sLLM per-topic execution control module 208 may be configured to perform control to select or newly create the per-topic sLLM execution module 203 and execute the same based on the real-time analysis result of the terminal-side question/answer analysis module 205. The sLLM may be configured to overcome the capacity limitation of the on-device AI terminal 200 and increase specialization by topic classification. It may be possible to focus on recent topics of interest by newly creating the per-topic sLLM or deleting the existing sLLM. Accordingly, it may be helpful in overcoming the capacity limitation.

The sLLM switching module 209 may be configured to perform switching to the corresponding per-topic sLLM execution module 203 by the control of the sLLM per-topic execution control module 208.

The terminal-side per-topic sLLM list storage module 210 may be configured to synchronize and store the per-topic sLLM list by the control of the sLLM per-topic execution control module 208.

The per-topic sLLM list providing module 211 may be configured to provide the per-topic sLLM list stored in the terminal-side per-topic sLLM list storage module 210 to the companion robot 300 in real time.

The user medication instruction module 212 may be configured to receive the user's medication information from the user medication information providing module 104 of the on-device AI control server 100 and perform medication instruction according to the received medication information through the Bluetooth communication performed by the terminal-side Bluetooth module 204.

The companion robot 300 may include a user database 301, an on-device AI terminal database 302, a robot-side per-topic sLLM list database 303, a camera module 304, a facial recognition module 305, a microphone module 306, a voiceprint analysis module 307, an automated conversation module 308, a speaker module 309, a user recognition module 310, a Bluetooth connection control module 311, a robot-side Bluetooth module 312, a robot-side question/answer module 313, a robot-side question/answer analysis module 314 and a robot operation control module 315.

Hereinafter, a detailed description will be provided.

The user database 301 may be configured to store the user information received from the user information providing module 102 of the on-device AI control server 100. The user information may be information about the plurality of users.

The on-device AI terminal database 302 may be configured to store the on-device AI terminal information received from the user on-device AI terminal information providing module 103 of the on-device AI control server 100.

The robot-side per-topic sLLM list database 303 may be configured to store the per-topic sLLM list received in real time from the per-topic sLLM list providing module 211 of the on-device AI terminal 200.

The camera module 304 may be configured to generate a front image.

The facial recognition module 305 may be configured to capture the user in the front image generated by the camera module 304 and recognize the captured user's face.

The microphone module 306 may be configured to collect the user's voice.

The voiceprint analysis module 307 may be configured to perform voiceprint analysis using the voice collected by the microphone module 306.

The automated conversation module 308 may be configured to make automated conversation with the user by the analysis of the voice collected by the microphone 306.

The speaker module 309 may be configured to output the voice of the companion robot 300 according to the automated conversation performed by the automated conversation module 308.

The user recognition module 310 may be configured to recognize the user according to the facial recognition result of the facial recognition module 305 and the voiceprint analysis result of the voiceprint analysis module 307 by referring to the user database 301. That is, the user recognition module 310 may recognize a conversation counterpart in front of the companion robot 300.

The Bluetooth connection control module 311 may perform control to make Bluetooth connection to the on-device AI terminal 200 of the user recognized by the user recognition module 310 by referring to the on-device AI terminal information stored in the on-device AI terminal database 302.

When there is a plurality of users in front and they are all pre-registered users, Bluetooth connection may be made to each user's on-device AI terminal 200 to enable conversation with each user and question asking/answering with the corresponding on-device AI terminal 200.

Additionally, the Bluetooth connection control module 311 may perform control to make Bluetooth connection to the on-device AI terminal 200 including the per-topic sLLM execution module 203 by the analysis of the robot-side question/answer analysis module 313 by referring to the per-topic sLLM list stored in the robot-side per-topic sLLM list database 303.

The robot-side Bluetooth module 312 may be configured to perform Bluetooth communication by making Bluetooth connection with the corresponding on-device AI terminal 200 by the control of the Bluetooth connection control module 311.

The robot-side question/answer module 313 may be configured to ask and answer questions with the on-device AI terminal 200 through the Bluetooth communication performed by the terminal-side Bluetooth module 204 based on the automated conversation with the user.

The robot-side question/answer analysis module 314 may be configured to perform real-time analysis of the questions and answers performed by the robot-side question/answer module 313.

The robot operation control module 315 may be configured to control the operation for medication guidance according to the medication instruction performed through the Bluetooth communication performed by the robot-side Bluetooth module 312.

In this instance, the robot operation control module 315 may be configured to determine whether the user currently recognized through the user recognition module 310 matches a target user for medication instruction by comparing them, and as a result of the determination, when they match each other, to provide the user with the prepared medicine in a medication box (not shown) of the companion robot 300 at the timing and amount of medication according to the medication instruction, and control the speaker module 309 to output a medication guidance voice.

In addition, the robot operation control module 315 may be configured to control the camera module 304 to take the user's medication process to generate a medication video.

Meanwhile, the companion robot 300 may further include a medication video monitoring module (not shown), a user behavior/condition analysis module (not shown), a user abnormal situation monitoring module (not shown) and an emergency call control module (not shown).

The medication video monitoring module (not shown) may be configured to determine whether the user has taken the medication in real time by analysis of the medication video generated by the camera module 304.

Additionally, the user behavior/condition analysis module (not shown) may be configured to capture the user in the front image generated by the camera module 304 and analyze the captured user's behavior and condition in real time. The user behavior/condition analysis module (not shown) may be configured to perform real-time analysis of the behavior or condition such as heart attack or seizure, and analysis of mental confusion or mental disorder.

Additionally, the user abnormal situation monitoring module (not shown) may be configured to identify an abnormal situation by controlling the automated conversation module 308 to ask questions to the user in real time according to the real-time analysis result of the user behavior/condition analysis module (not shown).

The emergency call control module (not shown) may control the on-device AI terminal 200 to automatically make an emergency call through the Bluetooth communication performed by the robot-side Bluetooth module 312 based on the monitoring result of the user abnormal situation monitoring module (not shown). The emergency call control module (not shown) may perform control to make an emergency call to doctors, 119 (emergency number), police or pre-registered caregivers' phone numbers.

The robot operation control module 315 may be configured to provide the user with the corresponding emergency medication prepared in the medication box (not shown) in real time based on the monitoring result of the user abnormal situation monitoring module (not shown). For example, tranquilizers or medications for panic disorder may be provided.

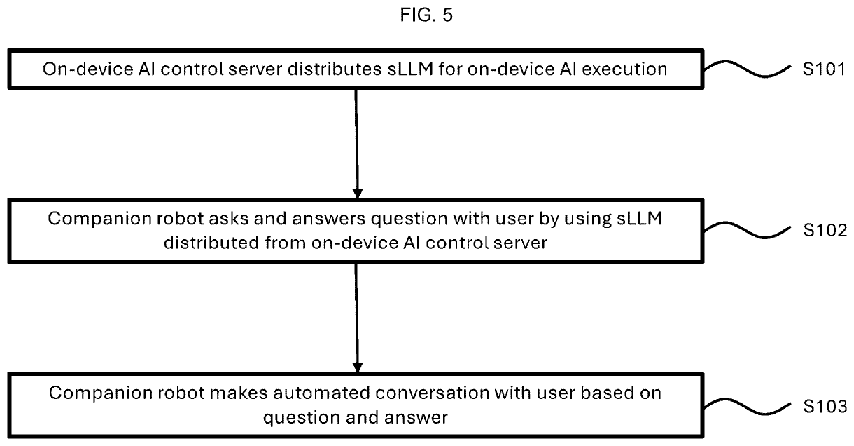

FIG. 5 is a flowchart of a robot control method using on-device AI according to an embodiment of the present disclosure.

Referring to FIG. 5, the on-device AI control server 100 distributes the sLLM for on-device AI execution (S101).

In this instance, the on-device AI control server 100 may be configured to distribute the sLLM by over-the-air programming (OTA).

Subsequently, the companion robot 300 asks and answers questions with the user by using the sLLM distributed from the on-device AI control server 100 (S102).

Subsequently, the companion robot 300 makes automated conversation with the user based on the questions and answers (S103).

Although the present disclosure has been hereinabove described with reference to the embodiments, those skilled in the art will understand that a variety 5 of modifications and changes may be made to the present disclosure without departing from the spirit and scope of the present disclosure set forth in the appended claims.

What is claimed is:

1. A robot control system using on-device artificial intelligence (AI), comprising:
an on-device AI control server configured to distribute a smaller Large Language Model (sLLM) for on-device AI execution; and
a companion robot configured to ask and answer a question with a user by using the sLLM distributed from the on-device AI control server.

2. The robot control system using on-device AI according to claim 1,
wherein the companion robot is configured to:
make automated conversation with the user based on the question and answer.

3. The robot control system using on-device AI according to claim 1,
wherein the on-device AI control server is configured to:
distribute the sLLM by an over-the-air (OTA) method.

4. A robot control method using on-device artificial intelligence (AI), comprising the steps of:
distributing, by an on-device AI control server, a smaller Large Language Model (sLLM) for on-device AI execution; and
asking and answering, by a companion robot, a question with a user by using the sLLM distributed from the on-device AI control server.

5. The robot control method using on-device AI according to claim 4, further comprising:
making, by the companion robot, automated conversation with the user based on the question and answer.

6. The robot control method using on-device AI according to claim 5,
wherein the step of distributing, by the on-device AI control server, the sLLM for on-device AI execution comprises distributing the sLLM by an over-the-air (OTA) method.
